(19) United States
(12) Patent Application Publication
(10) Pub. No.: US 2026/0333551 A1
(43) Pub. Date: Oct. 22, 2026

(54) ELECTRONIC DEVICE WITH COMPUTING SUBSYSTEM INDEPENDENT HARD RESET CAPABILITY

(71) Applicant: UBICQUIA, INC., FORT LAUDERDALE, FL (US)

(72) Inventors: Ivan Quiroz, Dallas, TX (US); Gustavo Armando Suarez, Coral Springs, FL (US); Joaquin Enrique Hing Batista, Miramar, FL (US)

(21) Appl. No.: 19/655,628

(22) Filed: Apr. 22, 2026

Related U.S. Application Data
(60) Provisional application No. 63/792,904, filed on Apr. 22, 2025.

(51) Int. Cl. H05B 47/19; G05B 15/02

(52) U.S. Cl. CPC H05B 47/19; G05B 15/02

(57) ABSTRACT

An electronic device includes control and computing subsystems, an AC-to-DC power supply, a controllable switching device coupled to the power supply, and a power interface that receives externally sourced AC power. The control subsystem includes a wireless communication interface to receive remote control signals and a processor that performs control operations responsive to the remote control signals. The computing subsystem, when powered on, performs computing operations independent of control operations performed by the control subsystem. Responsive to receiving a computing subsystem reset signal from a remote control system, the control subsystem issues a control signal to the switching device causing it to enter a state prohibiting DC power from passing to the computing subsystem. After a passage of time, the control subsystem automatically issues another control signal to the switching device causing it to enter a different state permitting power to pass from the power supply to the computing subsystem.

### CROSS-REFERENCE TO RELATED APPLICATIONS

The present application claims the benefit of and priority upon U.S. Provisional Patent Application No. 63/792,904, which was filed on Apr. 22, 2025, and is incorporated herein by this reference as if fully set forth herein.

### TECHNICAL FIELD

The present disclosure relates generally to electronic devices that include two or more functionally independent subsystems and, more particularly, to an electronic device capable of performing a hard reset of one subsystem without resetting or rebooting all the subsystems.

### BACKGROUND

An electronic device containing multiple processor-based subsystems may occasionally require some but not all the subsystems to be rebooted, reset, or the like due to malfunctions or other problems. In such cases, a hard reset of the electronic device is performed by temporarily removing and then restarting power, thereby causing all the device's subsystems to reset or reboot regardless of whether they need it or not. The unnecessary resetting of properly functioning subsystems during a hard reset of an electronic device may cause undesired processing or other performance outages while the electronic device is being reset.

### SUMMARY

According to some embodiments of the present disclosure, an electronic device includes an electrical power interface configured to receive alternating current (AC) power from an external power source, a control subsystem with its own AC-to-DC power supply, a computing subsystem operable when powered on to perform computing operations that are independent of control operations performed by the control subsystem, a supplemental AC-to-DC power supply for powering the computing subsystem and optional accessories (such as cameras or other sensors), and a controllable switching device, such as a relay or a semiconductor or solid-state switch (e.g., a metal-oxide-semiconductor field-effect transistor (MOSFET) switch), to selectively permit or prohibit direct current (DC) power from being supplied by the supplemental power supply to the computing subsystem based on control signals from the control subsystem. In addition to a power supply, the control subsystem includes a wireless communication interface operable to receive control signals from a remote control system over a wireless network and a processor that, among other things, performs control operations according to stored operating instructions (e.g., software or firmware) and is responsive to the control signals received from the remote control system. The control subsystem's processor and wireless communication interface use DC power supplied by the control subsystem's power supply. The switching device is configured to: (i) enter a first state, responsive to receipt of a first control signal from the control subsystem's processor, permitting DC power from the supplemental power supply to pass to the computing subsystem; and (ii) enter a second state, responsive to receipt of a second control signal from the control subsystem's processor, prohibiting DC power from passing to the computing subsystem. The processor of the control subsystem provides the second control signal to the controllable switching device responsive to receipt of a computing subsystem reset control signal from the remote control system and subsequently, after passage of a threshold period of time (e.g., 5-10 seconds or such other period of time necessary to reset or reboot the particular computing subsystem and its processor(s)), automatically provides the first control signal to the controllable switching device.

The controllable switching device may be positioned between the electrical power interface and an input to the supplemental power supply or between an output of the supplemental power supply and a DC power bus or other DC power input of the computing subsystem or its processor(s). When positioned between the electrical power interface and an input to the supplemental power supply, the controllable switching device may be included as part of the control subsystem, included as part of the supplemental power supply, or positioned on a printed circuit board that includes the control subsystem or the supplemental power supply. When positioned between the output of the supplemental power supply and a DC power bus or other DC power input of the computing subsystem, the switching device may be included as part of the computing subsystem, included as part of the supplemental power supply, or positioned on a printed circuit board that includes the computing subsystem or the supplemental power supply.

In some embodiments, the control subsystem includes the controllable switching device, and the switching device is positioned between the electrical power interface and the supplemental power supply. In other embodiments, the computing subsystem includes the controllable switching device, and the switching device is electrically coupled to an output of the supplemental power supply.

In some embodiments, the controllable switching device is a normally open device while in other embodiments, the controllable switching device is a normally closed device. When the switching device is normally open, the control signal that causes the switching device to enter a state permitting DC power from the supplemental power supply to pass to the computing subsystem causes the switching device to close and the control signal that causes the switching device to enter a state prohibiting DC power from passing to the computing subsystem causes the switching device to open. By contrast, when the switching device is normally closed, the control signal that causes the switching device to enter a state prohibiting DC power from passing to the computing subsystem causes the switching device to open and the control signal that causes the switching device to enter a state permitting DC power from the supplemental power supply to pass to the computing subsystem causes the switching device to close.

In some embodiments, the electronic device is a streetlight-mountable, multi-function device or platform in which the control subsystem also performs lighting control operations for the streetlight to which the electronic device is mounted. In such embodiments or in other embodiments, the computing operations performed by the computing subsystem include processing data received from one or more sensors (e.g., cameras, motion sensors, optical sensors, etc.) coupled to the computing subsystem.

In some embodiments in which the computing subsystem processes data received from one or more sensors, the electronic device further includes one or more Power over Ethernet (PoE) ports. In such embodiments, each sensor is coupled to the computing subsystem through a respective PoE port (e.g., connector, jack, or socket). The PoE port delivers DC power from the supplemental power supply to and receives data from the sensor that is coupled to the PoE port.

The computing operations of the computing subsystem are performed according to the subsystem's stored operating instructions (e.g., software or firmware) and may be unrelated to, as well as independent of, the control operations performed by the control subsystem. For example, where the control subsystem controls dimming operations of a streetlight fixture to which the electronic device is connected and receives AC power, the computing subsystem may perform edge processing of image or other sensor data received from a sensor attached to the electronic device. In such a case, the computing operations performed by the computing subsystem are independent of the control operations performed by the control subsystem (e.g., the computing operations are not a subset or otherwise under control of the control subsystem's processor) and are unrelated to the control operations performed by the control subsystem (e.g., the computing operations do not relate to lighting control).

According to other embodiments of the present disclosure, an electronic device includes an electrical power interface configured to receive AC power from an external power source, a control subsystem with its own AC-to-DC power supply, a plurality of computing subsystems where each computing subsystem is operable when powered on to perform respective computing operations that are independent of control operations performed by the control subsystem, a supplemental AC-to-DC power supply for powering the computing subsystems and optional accessories such as cameras or other sensors, and a plurality of controllable switching devices where each switching device (e.g., a relay or a semiconductor or solid-state switch) selectively permits or prohibits DC power from being supplied by the supplemental power supply to a respective computing subsystem based on control signals from the control subsystem. In addition to a power supply, the control subsystem includes a wireless communication interface operable to receive reset and other control signals from a remote control system over a wireless network and a processor that, among other things, performs control operations according to stored operating instructions (e.g., software or firmware) and is responsive to the control signals received from the remote control system. The control subsystem processor and the wireless communication interface use DC power supplied by the control subsystem's power supply.

Each switching device is configured to (i) enter a first state, responsive to receipt of a first control signal from the control subsystem processor, permitting DC power from the supplemental power supply to pass to a respective computing subsystem, and (ii) enter a second state, responsive to receipt of a second control signal from the control subsystem processor, prohibiting DC power from passing to the respective computing subsystem. The processor of the control subsystem provides the second control signal to a switching device associated with a particular computing subsystem responsive to receipt of a reset control signal from the remote control system identifying the particular computing subsystem to be reset or rebooted and subsequently, after passage of a period of time (e.g., 5-10 seconds or such other period of time necessary to reset or reboot the particular computing subsystem and its processor(s)), automatically provides the first control signal to the switching device associated with the particular computing subsystem.

The computing operations of some or all the computing subsystems are performed according to the particular subsystem's stored operating instructions (e.g., software or firmware) and may be unrelated to, as well as independent of, the control operations performed by the control subsystem. For example, where the control subsystem controls dimming operations of a streetlight fixture to which the electronic device is connected and receives AC power, the computing subsystems may perform edge processing of image, video, or other sensor data received from sensors attached to the electronic device. In such a case, the computing operations performed by the computing subsystems are independent of the control operations performed by the control subsystem (e.g., the computing operations are not a subset or otherwise under control of the control subsystem's processor) and are unrelated to the control operations performed by the control subsystem (e.g., the computing operations do not relate to lighting control).

For embodiments in which the electronic device includes multiple computing subsystems, each switching device is preferably positioned between an output of the supplemental power supply and a DC power supply bus or other DC power input of the switching device's associated computing subsystem. In such a case, the switching device may be included as part of the computing subsystem, included as part of the supplemental power supply, or positioned on a printed circuit board that includes the computing subsystem or the supplemental power supply.

In some embodiments, the controllable switching devices are normally open devices while in other embodiments, the controllable switching devices may be normally closed devices or a mixture of normally open devices and normally closed devices. When a switching device is a normally open device, the control signal that causes the switching device to enter a state permitting DC power from the supplemental power supply to pass to the associated computing subsystem causes the switching device to close and the control signal that causes the switching device to enter a state prohibiting DC power from passing to the associated computing subsystem causes the switching device to open. By contrast, when a switching device is a normally closed device, the control signal that causes the switching device to enter a state prohibiting DC power from passing to the associated computing subsystem causes the switching device to open and the control signal that causes the switching device to enter a state permitting DC power from the supplemental power supply to pass to the associated computing subsystem causes the switching device to close.

In some embodiments, the electronic device is a streetlight-mountable, multi-function device or platform in which the control subsystem also performs lighting control operations for the streetlight to which the electronic device is connected. In such embodiments or in other embodiments, the computing operations performed by any particular computing subsystem may include processing data received from one or more sensors (e.g., cameras, motion sensors, optical sensors, etc.) coupled to the computing subsystem.

In some embodiments in which the computing subsystems process data received from a plurality of sensors, the electronic device includes a plurality of PoE ports. In such embodiments, one or more sensors are coupled to a respective computing subsystem through one or more PoE ports (e.g., connectors, jacks, or sockets), and each PoE port delivers DC power from the supplemental power supply to and receives data from the sensor(s) to which the PoE port is coupled.

According to other embodiments of the present disclosure, an electronic device includes an electrical power interface configured to receive AC power from an external power source, a control subsystem with its own AC-to-DC power supply, a plurality of computing subsystems where each computing subsystem is operable when powered on to perform respective computing operations that are independent of control operations performed by the control subsystem, a supplemental AC-to-DC power supply for powering the computing subsystems and optional accessories such as cameras or other sensors, and a plurality of controllable switching devices where each switching device (e.g., a relay or a semiconductor or solid-state switch) selectively permits or prohibits DC power from being supplied by the supplemental power supply to a respective computing subsystem based on control signals from the control subsystem. In addition to a power supply, the control subsystem includes a wireless communication interface operable to receive reset and other control signals from a remote control system over a wireless network and a processor that, among other things, performs control operations according to stored operating instructions (e.g., software or firmware) and is responsive to the control signals received from the remote control system. The control subsystem processor and the wireless communication interface use DC power supplied by the control subsystem's power supply.

According to other embodiments of the present disclosure, an electronic device includes an electrical power interface configured to receive AC power from an external power source, a control subsystem including a processor that performs control operations according to stored operating instructions, a computing subsystem operable when powered on to perform computing operations that are independent of the control operations performed by the control subsystem, a single AC-to-DC power supply for powering the control subsystem, the computing subsystem and optional accessories (such as cameras or other sensors), and a controllable switching device, such as a relay or a semiconductor or solid-state switch, to selectively permit or prohibit DC power from being supplied by the power supply to the computing subsystem (and optionally the control subsystem) based on control signals from the control subsystem. The control subsystem also includes a wireless communication interface operable to receive control signals from a remote control system over a wireless network and may optionally include a charge storage device, such as a battery or capacitor, to enable minor control operations, such as activating or deactivating the switching device, for embodiments in which the switching device is configured to selectively permit or prohibit DC power from being supplied by the power supply to both the control subsystem and the computing subsystem. The control subsystem's processor performs control operations, such as entire device and computing subsystem resets, software updates, and so forth, responsive to control signals received from the remote control system, as well as may perform various other control operations according to its stored operating instructions (e.g., software or firmware).

The switching device is configured to: (i) enter a first state, responsive to receipt of a first control signal from the control subsystem's processor, permitting DC power from the power supply to pass to the computing subsystem; and (ii) enter a second state, responsive to receipt of a second control signal from the control subsystem's processor, prohibiting DC power from passing to the computing subsystem. The processor of the control subsystem provides the second control signal to the controllable switching device responsive to receipt of a computing subsystem reset control signal from the remote control system and subsequently, after passage of a period of time (e.g., 5-10 seconds or such other period of time necessary to reset or reboot the particular computing subsystem and its processor(s)), automatically provides the first control signal to the controllable switching device to allow the computing subsystem to be powered back on.

The controllable switching device may be positioned between the electrical power interface and an input to the power supply or between an output of the power supply and a DC power bus or other DC power input of the computing subsystem or its processor(s). When positioned between the electrical power interface and an input to the power supply, the controllable switching device may be included as part of the control subsystem, included as part of the power supply, or positioned on a printed circuit board that includes the control subsystem or the power supply. When positioned between the output of the power supply and a DC power input of the computing subsystem or to its processor(s), the switching device may be included as part of the computing subsystem, included as part of the power supply, or positioned on a printed circuit board that includes the computing subsystem or the power supply.

In some embodiments, the controllable switching device is a normally open device while in other embodiments, the controllable switching device is a normally closed device. When the switching device is normally open, the control signal that causes the switching device to enter a state permitting DC power from the power supply to pass to the computing subsystem causes the switching device to close and the control signal that causes the switching device to enter a state prohibiting DC power from passing to the computing subsystem causes the switching device to open. By contrast, when the switching device is normally closed, the control signal that causes the switching device to enter a state prohibiting DC power from passing to the computing subsystem causes the switching device to open and the control signal that causes the switching device to enter a state permitting DC power from the power supply to pass to the computing subsystem causes the switching device to close.

In some embodiments in which the computing subsystem processes data received from one or more sensors, the electronic device further includes one or more Power over Ethernet (PoE) ports. In such embodiments, each sensor is coupled to the computing subsystem through a respective PoE port (e.g., connector, jack, or socket). The PoE port delivers DC power from the power supply to and receives data from the sensor that is coupled to the PoE port.

The computing operations of the computing subsystem are performed according to the subsystem's stored operating instructions (e.g., software or firmware) and may be unrelated to, as well as independent of, the control operations performed by the control subsystem. For example, where the control subsystem controls dimming operations of a streetlight fixture to which the electronic device is connected and receives AC power, the computing subsystem may perform edge processing of image or other sensor data received from a sensor attached to the electronic device. In such a case, the computing operations performed by the computing subsystem are independent of the control operations performed by the control subsystem (e.g., the computing operations are not a subset or otherwise under control of the control subsystem's processor) and are unrelated to the control operations performed by the control subsystem (e.g., the computing operations do not relate to lighting control).

The single power supply embodiment of the present disclosure may also be used in electronic devices that include multiple computing subsystems. In such a case, multiple controllable switching devices may be used with each switching device preferably positioned between an output of the power supply and a DC power supply bus or other DC power input of the switching device's associated computing subsystem. In such a case, the switching device may be included as part of the associated computing subsystem or positioned on a printed circuit board that includes the associated computing subsystem or the power supply (e.g., where the power supply has multiple output ports).

In other embodiments, an electronic device can include an electrical power interface configured to receive AC power from an external power source, and a control subsystem including a wireless communication interface operable to receive control signals from a remote control system over a wireless network to control at least a first function, a processor that performs control operations according to stored operating instructions and responsive to the control signals received from the remote control system, and a first power supply electrically coupled to the electrical power interface, the first power supply configured to convert AC power received from the electrical power interface into DC power for use at least by the one or more processors and the wireless communication interface.

In some embodiments, the electronic device further includes a computing subsystem operable to perform computing operations according to stored operating instructions when powered on, the computing operations being independent of and optionally unrelated to the at least the first function performed by the control subsystem, a second power supply coupled to the electrical power interface, the second power supply configured to convert AC power received from the electrical power interface into DC power for use by at least the computing subsystem to control at least a second function, and a controllable switching device operably coupled to the processor of the control subsystem and having an input and an output, the controllable switching device being configured to enter a first state, responsive to receipt of a first control signal from the processor of the control subsystem, in which power from the second power supply passes from the input to the output and to enter a second state, responsive to receipt of a second control signal from the processor of the control subsystem, in which power from the second power supply is prevented from passing from the input to the output where the processor of the control subsystem provides the second control signal to the controllable switching device responsive to receipt of a computing subsystem reset signal from the remote control system and subsequently provides the first control signal to the controllable switching device automatically after passage of a period of time.

In some embodiments at least the first function is a luminaire control function and at least the second function is at least one of wireless communications control, edge processing control, PoE control, and Ethernet control.

### BRIEF DESCRIPTION OF THE DRAWINGS

Non-limiting and non-exhaustive embodiments are described with reference to the following drawings, wherein like reference numerals refer to like elements throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings.

FIG. 1 illustrates a block diagram of an exemplary electronic device configured to wirelessly receive a communication subsystem reset control signal from a remote control system and responsive thereto execute an independent hard reset of a computing subsystem of the electronic device without resetting a control subsystem of the electronic device, in accordance with some embodiments of the present disclosure.

FIG. 2 illustrates a block diagram of another exemplary electronic device configured to wirelessly receive communication subsystem reset control signals from a remote control system and responsive thereto execute independent hard resets of identified computing subsystems of the electronic device without resetting a control subsystem or unidentified computing subsystems of the electronic device, in accordance with other embodiments of the present disclosure.

FIG. 3 illustrates an exemplary electronic device in the form of a streetlight-mountable device attached to a streetlight luminaire or lighting fixture, in accordance with other embodiments of the present disclosure.

FIG. 4 illustrates yet another exemplary electronic device in the form of a streetlight-mountable device attached to a streetlight luminaire or lighting fixture and a streetlight pole arm, in accordance with other embodiments of the present disclosure.

FIG. 5 illustrates a block diagram of still another exemplary electronic device configured to wirelessly receive a communication subsystem reset control signal from a remote control system and responsive thereto execute an independent hard reset of a computing subsystem of the electronic device without resetting a control subsystem of the electronic device, in accordance with further embodiments of the present disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. Also in these instances, well-known structures may be omitted or shown and described in reduced detail to avoid unnecessarily obscuring descriptions of the embodiments.

Although the embodiments described are particularly useful in the context of smart street light devices, the embodiments are not limited to such lighting devices and can be applicable to many electronic devices generally having a control subsystem and one or more independently operating computing subsystems.

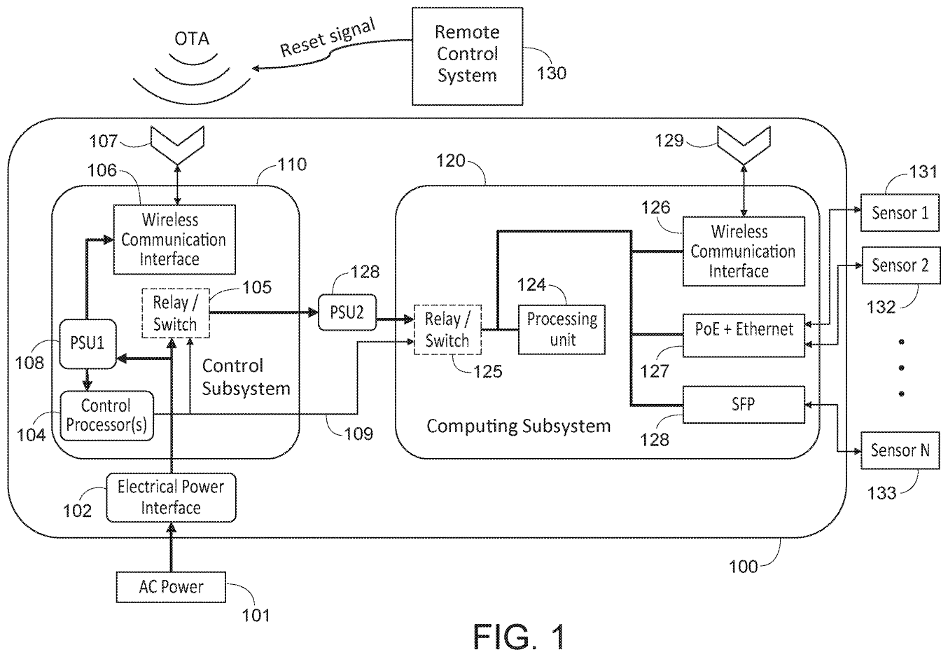

FIG. 1 illustrates a block diagram of an exemplary electronic device 100 configured to wirelessly receive a communication subsystem reset control signal from a remote control system 130 and responsive thereto execute an independent hard reset of a computing subsystem 120 of the electronic device 100 without resetting a control subsystem 110 of the electronic device 100, in accordance with some embodiments of the present disclosure. The electronic device 100 includes an electrical power interface 102, a control subsystem 110, a computing subsystem 120, an AC-to-DC power supply (PSU2) 128 for supplying DC power to the computing subsystem 120 and optional accessories, such as sensors 131-133, a controllable switching device 105, 125, such as a relay or a semiconductor or solid-state switch (e.g., a metal-oxide-semiconductor field-effect transistor (MOSFET) switch), and one or more antennas 107, 129 (two shown for illustration). The electrical power interface 102 may be a plug or other connector, or a set of wires for hardwired implementations, and is configured to receive AC power from an external power source 101, such as a socket or other connector of a streetlight fixture, a streetlight pole or pole arm, or any other AC power source.

The control subsystem 110 includes, inter alia, a processor 104, its own AC-to-DC power supply (PSU1) 108, a wireless communication interface 106, and, in some embodiments, a switching device 105. The wireless communication interface 106 is coupled to an antenna 107 and operable to receive control signals from the remote control system 130, such as a remote server or a web application operating in a cloud service environment, over a wireless network. The wireless communication interface 106 may be an LTE, 5G, Wi-Fi, or other wireless modem. The processor 104 performs control operations according to stored operating instructions (e.g., software or firmware) and is responsive to control signals received from the remote control system 130.

When powered on and operating, the computing subsystem 120 is operable to perform computing operations that are independent of the control operations performed by the control subsystem 110. In many cases, the computing operations performed by the computing subsystem 120 are also unrelated to the control or other operations performed by the control subsystem 110. For example, the electronic device 100 may be a multi-function computing platform to meet multiple independent needs, such as to perform lighting control operations for a streetlight fixture while contemporaneously running an independent public safety application in coordination with a camera or other sensor 131-133, such as a video management system (VMS) application in support of law enforcement operations. The computing subsystem 120 includes a processing unit 124 (which may include one or more processors), an optional wireless communication interface 126, one or more optional accessory ports 127, 128, and, in some embodiments, a controllable switching device 125. The wireless communication interface 126 may be a higher speed modem than the modem used to implement the wireless communication interface 106 of the control subsystem 110 (e.g., an LTE Cat 4 modem instead of an LTE Cat 1 modem). In such a case, the wireless communication interface 126 may be coupled to a separate antenna 129 with appropriate bandwidth.

In some embodiments, the computing subsystem 120 includes accessory ports, such as one or more PoE ports 127, ethernet ports, or small form-factor pluggable (SFP) ports 128. The accessory ports 127, 128 may be used to connect accessories, such as cameras or other sensors 131-133, to the computing subsystem 120 to enable the processing unit 124 of the computing subsystem 120 to perform one or more computer processes, such as edge computing, switching (e.g., where the computing subsystem 120 is essentially functioning as a managed switch), and other processes, on data output by the accessories. In embodiments that utilize PoE ports 127, one or more sensors 131, 132 may be coupled to the computing subsystem 120 through the PoE ports 127 (e.g., connectors, jacks, or sockets), and each PoE port 127 delivers DC power from PSU2 128 to and receives data from the sensor(s) 131, 132 to which the PoE port 127 is coupled.

In general, the switching device 105, 125 is configured to: (i) enter a first state, responsive to receipt of a first control signal (e.g., an “ON” signal) from the control subsystem's processor 104, permitting DC power from PSU2 128 to pass to the computing subsystem; and (ii) enter a second state, responsive to receipt of a second control signal (e.g., an “OFF” signal) from the control subsystem's processor 104, prohibiting DC power from passing to the computing subsystem 120. The processor 104 of the control subsystem 110 provides the OFF signal to the controllable switching device 105, 125 responsive to receipt of a computing subsystem reset control signal (“Reset signal” in FIG. 1) from the remote control system 130 and subsequently, after passage of a period of time (e.g., 5-10 seconds or such other period of time necessary to reset or reboot the particular computing subsystem 120 and its processor(s) 124), automatically provides the ON signal to the controllable switching device 105, 125 to allow DC power to again pass to the computing subsystem 120.

As illustrated in FIG. 1, the controllable switching device 105, 125 may be positioned between the electrical power interface 102 and an input to PSU2 128 or between an output of PSU2 128 and a DC power bus or other DC power input of the computing subsystem 120 or its processor(s) 124. When positioned between the electrical power interface 102 and an input to PSU2 128, the controllable switching device 105 may be included as part of the control subsystem 110 (as shown in FIG. 1), included as part of PSU2 128, or positioned on a printed circuit board that includes the control subsystem 110 or PSU2 128. When positioned between the output of the supplemental power supply and a DC power bus or other DC power input of the computing subsystem 120, the switching device 125 may be included as part of the computing subsystem 110, included as part of PSU2 128, or positioned on a printed circuit board that includes the computing subsystem 110 or PSU2 128. The preferred positioning for the switching device 105, 125 may depend on a variety of factors, including the overall configuration of the electronic device 100, the voltage of the AC power 101, radiated emissions issues, component costs, and other factors.

The computing operations performed by the computing subsystem 120 through its processing unit(s) 124 are executed according to the subsystem's stored operating instructions (e.g., software or firmware) and may be unrelated to, as well as independent of, the control operations performed by the control subsystem 110 through its processor 104. For example, where the control subsystem 110 controls dimming operations of a streetlight fixture to which the electronic device 100 is connected and receives AC power 101, the computing subsystem 120 may perform edge processing of image or other sensor data received from a sensor 131-133 attached to the electronic device 100. In such a case, the computing operations performed by the computing subsystem 120 are independent of the control operations performed by the control subsystem 110 (e.g., the computing operations are not a subset or otherwise under control of the control subsystem's processor 104) and are unrelated to the control operations performed by the control subsystem 110 (e.g., the computing operations do not relate to lighting control).

Operationally, when a hard reset of a computing subsystem 120 of the electronic device 150 is needed without impacting operation of a control subsystem 110 of the device 150, an over-the-air (OTA) reset signal can be sent to the control subsystem 110.

Responsive to receipt of the reset signal, the control subsystem 110 cuts the power to the computing subsystem 120 by opening a switching device 125 of the computing subsystem 120 for a certain time and then automatically closing the switching device 125. This power cycling allows the computing subsystem 120 to restart all its processes from a known state after the switching device 125 is closed. Operation of the control subsystem 110 remains unaffected and maintains uninterrupted operation.

The electronic device 100 may be installed at a location, such as on a streetlight, which is remote from the host server or other remote control system 130 that provides certain control signaling, software updates, and other information to the electronic device 100 via wireless or OTA communications. In some embodiments, this hard reset capability is effective for the computing subsystem 120 without affecting or significantly affecting operation of the control subsystem 110. Therefore, some embodiments can include two subsystems: a first one being a control subsystem 110, which runs the streetlight fixture control, and a second one being a computing subsystem 120, which performs edge processing, high speed wireless communications, and other functions for sensors and other accessories coupled to the computing subsystem 120. The first subsystem controls the flow of AC power 101 to pass through a switching device 105 to power the second subsystem 120. When a hard reset of the device 150 is needed, the remote control system 130 sends an OTA reset control signal to the electronic device 100. Responsive to receipt of the reset control signal, the control subsystem 110 cuts power to the computing subsystem 120 by opening the switching device 105 for a threshold period of time and then automatically closes the switching device 105 to restart the computing subsystem 120. This allows the computing subsystem 120 to start all its processes from a known state once the switching device 105 is closed. At the same time, while doing the hard reset of the computing subsystem 120, the control subsystem 110 maintains dimming or lighting control of the streetlight fixture uninterruptedly.

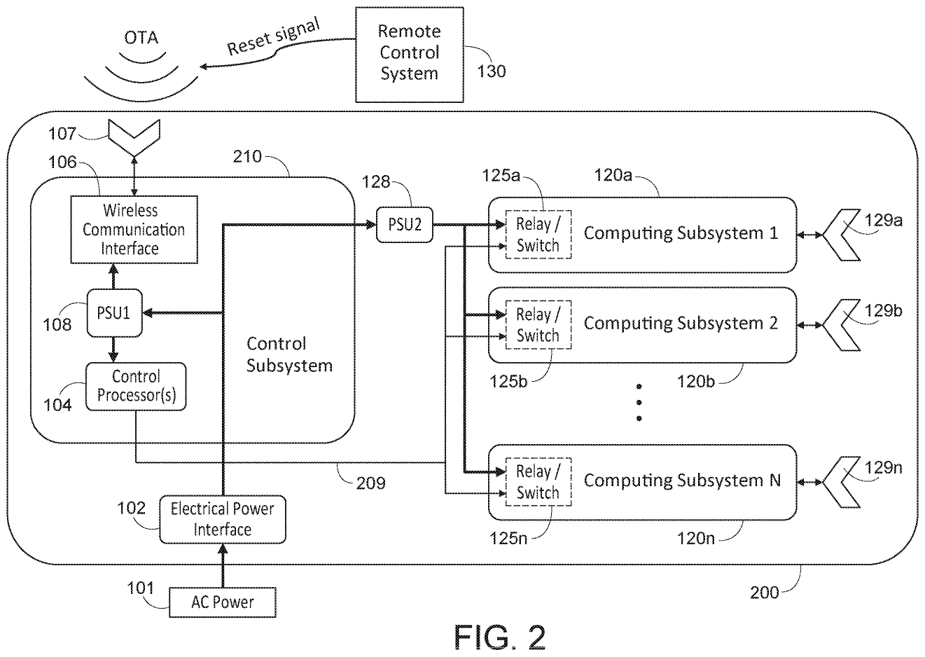

The independent hard reset capability described above in connection with a single computing subsystem 120 is also scalable to use with multiple computing subsystems 120a-120n with further reference to FIG. 2. FIG. 2 illustrates a block diagram of another exemplary electronic device 200 configured to wirelessly receive communication subsystem reset control signals from a remote control system 130 and responsive thereto execute independent hard resets of identified computing subsystems 120a-120n of the electronic device 200 without resetting a control subsystem 210 or unidentified computing subsystems of the electronic device 200, in accordance with other embodiments of the present disclosure. To perform a hard reset on one computing subsystem (e.g., computing subsystem 120a) after a reset signal identifying the affected computing subsystem is received by the control subsystem 210 from the remote control system 130, the control subsystem processor 104 may use a communication bus 209 or other signal path to provide the OFF signal to the switching device 125a for the affected computing subsystem 120a to be reset (power cycled). This same scheme can be followed to hard reset some or all the computing subsystems 120a-120n at the same time, on a one-off basis, or according to a pre-programmed sequence based on the content of the reset signal received from the remote control system 130.

The scaled, multiple computing subsystem embodiment illustrated in FIG. 2 operates in a manner similar to the single computing subsystem embodiment described above with respect to FIG. 1, except that, in the multiple computing subsystem embodiment, multiple switching devices 125a-125n are used on a one-to-one basis with a respective computing subsystem 120a-120n, and each switching device 125a-125n is positioned between an output of PSU2 128 and a DC power bus or other DC power input of its associated computing subsystem 120a-120n or its processor(s). Additionally, each computing subsystem 120a-120n may have its own unique wireless communication interface and processing unit(s) and wireless communications may occur over separate antennas 129a-129n.

In some embodiments and with reference back to FIG. 1, a smart computing system includes a remote control system 130 that remotely controls an electronic device 150. A wireless signal from the remote control system 130 can perform a hard reset of a computing subsystem 120 of the electronic device 100.

In some embodiments, an electronic device 100 can include an electrical power interface 102 configured to receive AC power from an external power source 101, and a control subsystem 110 including a wireless communication interface 106 operable to receive control signals from a remote controller 120 or remote control system over a wireless network via antenna 107, a processor (or processors) 104 that performs control operations according to stored operating instructions and responsive to the control signals received from the remote control system 120, and a first power supply 108 electrically coupled to the electrical power interface 102, the first power supply 108 configured to convert AC power received from the electrical power interface 102 into DC power for use at least by the one or more processors 104 and the wireless communication interface 106. The electronic device 100 can further include a computing subsystem 120 operable to perform computing operations according to stored operating instructions when powered on, the computing operations being independent of the control operations performed by the control subsystem 110, a second power supply 128 coupled to the electrical power interface 102, the second power supply 128 configured to convert AC power received from the electrical power interface 102 into DC power for use by at least the computing subsystem 120, and a controllable switching device 105, 125 operably coupled to the processor 104 of the control subsystem 110 and having an input and an output, the controllable switching device 105, 125 being configured to enter a first state, responsive to receipt of a first control signal from the processor 104 of the control subsystem, in which power from the second power supply 128 passes from the input to the output and to enter a second state, responsive to receipt of a second control signal from the processor 104 of the control subsystem, in which power from the second power supply is prevented from passing from the input to the output where the processor 104 of the control subsystem 110 provides the second control signal to the controllable switching device 105, 125 responsive to receipt of a computing subsystem reset signal from the remote control system 130 and subsequently provides the first control signal to the controllable switching device 125 automatically after passage of a period of time.

In some embodiments, the control subsystem 110 includes the controllable switching device 105, and the controllable switching device 105 is positioned between the electrical power interface 102 and the second power supply 128.

In some embodiments, the computing subsystem 120 includes the controllable switching device 125, and the controllable switching device 125 is electrically connected to an output of the second power supply 128.

In some embodiments, the controllable switching device may be implemented using two switching devices, first switching device 105 in the control subsystem 110 positioned between the electrical power interface 102 and the second power supply 128 and a second switching device 125 in the computing subsystem 120 electrically connected to an output of the second power supply 128.

In some embodiments, the controllable switching device is a normally open switching device while in some embodiments, the controllable switching device is a normally closed switching device.

In some embodiments, the electronic device 150 is a smart streetlight device such as a smart streetlight device having two subsystems further having a hard reset capability that independently controls one of two subsystems.

In some embodiments, the two subsystems include a utility control board that provides luminaire control and a compute board having a processing unit 124 that controls wireless communications, edge processing, Power over Ethernet (PoE), and Ethernet. In some embodiments, the computing subsystem 120 has the wireless communication interface 126 coupled to a separate antenna 127 to enable receipt of control signals and data from a remote control system.

In some embodiments with reference to FIG. 2, an electronic device 200 that can include an electrical power interface 102 configured to receive AC power from an external power source 101, and a control subsystem 210 including a wireless communication interface 106 operable to receive control signals via antenna 107 from the remote controller 130 or a remote control system over a wireless network, one or more processors 104 that perform control operations according to stored operating instructions and responsive to the control signals received from the remote control system, and a first power supply 108 electrically coupled to the electrical power interface, the first power supply 101 configured to convert AC power received from the electrical power interface 102 into DC power for use at least by the one or more processors 104 and the wireless communication interface 106. The electronic device 250 can further include a plurality of computing subsystems 120a-120n, each computing subsystem 120a-120n operable to perform respective computing operations according to stored operating instructions when powered on, the computing operations being independent of the control operations performed by the control subsystem 110, a second power supply 128 coupled to the electrical power interface 102, the second power supply 128 configured to convert AC power received from the electrical power interface 102 into DC power for use by at least the plurality of computing subsystems 120a-120n, and a plurality of controllable switching devices 125a-125n operably coupled to the one or more processors 104 of the control subsystem 210, each switching device 125a-125n having an input and an output and being associated with a respective computing subsystem 120a-120n of the plurality of computing subsystems 120a-120n, each switching device 125a-125n being configured to enter a first state, responsive to receipt of a first control signal from the one or more processors 104 of the control subsystem 110, in which power passes from the input to the output and to enter a second state, responsive to receipt of a second control signal from the one or more processors 104 of the control subsystem 110, in which power is prevented from passing from the input to the output where the one or more processors 104 of the control subsystem provides the second control signal to a switching device 125 associated with a particular computing subsystem responsive to receipt of a reset control signal identifying the particular computing subsystem from the remote control system 130 and subsequently, after the passage of a period of time, automatically provides the first control signal to the switching device 125.

In some embodiments, each computing subsystem 120a-120n includes a respective controllable switching device 125a-125n, and where the switching device 125a-125n is electrically connected to an output of PSU2 128.

In some embodiments, the plurality of controllable switching devices 125a-125n are positioned in the computing subsystems 120a-120n (one switching device 125 for each computing system 120), where each respective switching device 125a-125n is electrically connected to an output of PSU2 128.

In some embodiments, the controllable switching device is a normally open switching device and in other embodiments the controllable switching device is a normally closed switching device.

In some embodiments, the two subsystems include a control subsystem 110 that provides luminaire control and a computing subsystem that controls wireless communications, video and image processing, edge processing, Power over Ethernet (PoE), and Ethernet.

In some embodiments with reference to FIG. 1 again, an electronic device 150 can include an electrical power interface 102 configured to receive AC power from an external power source 101, and a control subsystem 110 including a wireless communication interface operable to receive control signals from a remote control system over a wireless network to control at least a first function, a processor 104 (or processors) that performs control operations according to stored operating instructions and responsive to the control signals received from the remote control system or remote controller 130, and a first power supply 108 electrically coupled to the electrical power interface 102, the first power supply 108 configured to convert AC power received from the electrical power interface 102 into DC power for use at least by the one or more processors 104 and the wireless communication interface 106.

In some embodiments, the electronic device 150 further includes a computing subsystem 120 operable to perform computing operations according to stored operating instructions when powered on, the computing operations being independent of the at least the first function performed by the control subsystem 110, a second power supply 128 coupled to the electrical power interface 102, the second power supply 128 configured to convert AC power received from the electrical power interface 102 into DC power for use by at least the computing subsystem 120 to control at least a second function, and a controllable switching device 105, 125 operably coupled to the processor 104 of the control subsystem 110 and having an input and an output, the controllable switching device 105, 125 being configured to enter a first state, responsive to receipt of a first control signal from the processor 104 of the control subsystem 110, in which power from the second power supply 128 passes from the input to the output and to enter a second state, responsive to receipt of a second control signal from the processor 104 of the control subsystem 110, in which power from the second power supply 128 is prevented from passing from the input to the output where the processor 104 of the control subsystem 110 provides the second control signal to the controllable switching device 105, 125 responsive to receipt of a computing subsystem reset signal from the remote control system 130 and subsequently, after passage of a period of time (e.g., 5-10 seconds), automatically provides the first control signal to the controllable switching device 105, 125.

In some embodiments the first function is a luminaire control function and the second function is at least one or more among wireless communications control, edge processing control, Power over Ethernet control, and Ethernet control.

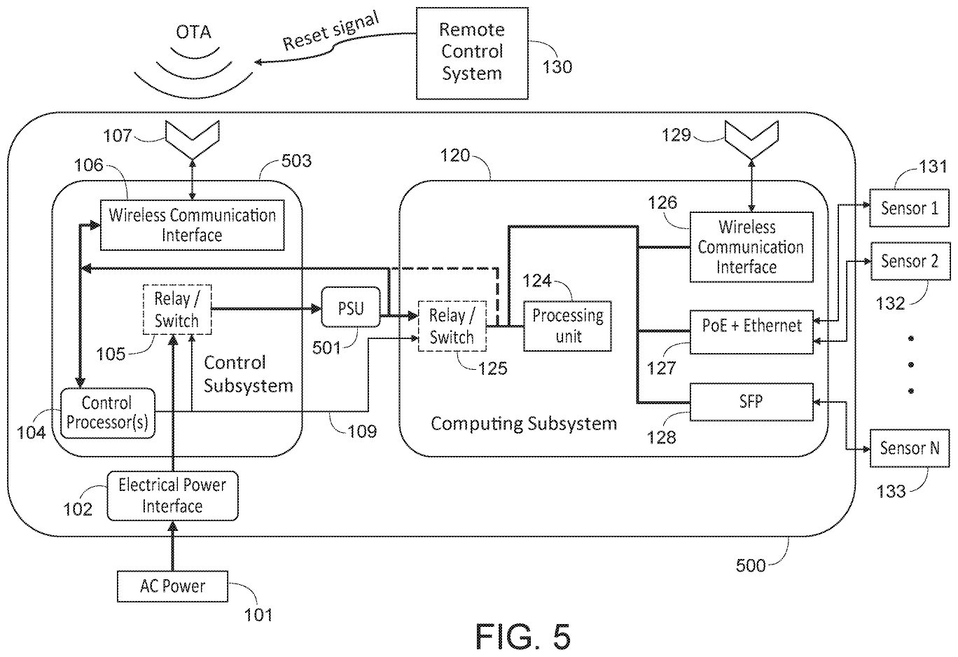

In some embodiments as illustrated in FIGS. 4 and 5, an electronic device 150, 250 in accordance with the present disclosure may be attached and electrically connected to a streetlight fixture 302, 402 to enable the electronic device 150, 250 to receive AC power from the streetlight fixture 302, 402 as an external AC power source 101. The AC power may be supplied to the electronic device 150, 250 through a socket or other connector integrated into the top of the streetlight fixture 302, 402 or through a connector or hardwiring in the streetlight pole 304, 404 or pole arm. The power conductors 306 feeding AC power to the streetlight also feed the AC power to the streetlight fixture 302, 304 and its topside connector.

The electronic devices 150, 250 illustrated in FIGS. 4 and 5 may be any of the electronic devices 100, 200, 500 described with respect to FIGS. 1, 2, and 5. Each such electronic device 100, 200, 300 can be a smart city platform that can integrate edge AI, microphones, cameras, lighting control, communication and other devices in one platform to help improve public safety, manage traffic, and deliver public Wi-Fi with greater ease and less cost on existing infrastructure or new infrastructure. Of course, the electronic device 100 as contemplated herein can be other devices and is not limited to the electronic hub device described. For example, the electronic device 100 could include, but is not limited to, a light control device, a power control device, a sensor device, a communication device, or any combination thereof. The list of electronic devices contemplated herein is not limited to the devices mentioned.

FIG. 5 illustrates a block diagram of another exemplary electronic device 500 configured to wirelessly receive a communication subsystem reset control signal from a remote control system 130 and responsive thereto execute an independent hard reset of a computing subsystem 120 of the electronic device 500 without resetting a control subsystem 503 of the electronic device 500, in accordance with further embodiments of the present disclosure. Similar to the electronic device 100 described above with respect to FIG. 1, the electronic device 500 includes an electrical power interface 102 configured to receive AC power from an external power source 101, a control subsystem 503 including a processor 104 that performs control operations according to stored operating instructions and in response to control signals received from a remote control system 130, a computing subsystem 102 operable when powered on to perform computing operations that are independent of the control operations performed by the control subsystem 110, and a controllable switching device 105, 125 to selectively permit or prohibit DC power from being supplied by the power supply 501 to the computing subsystem 120 based on control signals from the control subsystem 110. However, in contrast to the electronic device 100 described above with respect to FIG. 1, the electronic device 500 of FIG. 5 includes a single AC-to-DC power supply 501 for powering the control subsystem 110, the computing subsystem 120, and optional accessories 131-133 (such as cameras or other sensors). Therefore, in an embodiment in which the controllable switching device 125 is positioned between the output of the power supply 501 and a DC power bus or other DC power input of the computing subsystem 120, the power supply output feed to the control subsystem 110 may be located before the switching device 125 or at the output of the switching device 125.

When the power supply output feed to the control subsystem 110 is configured to be at the output of the switching device 125, the switching device 125 control subsystem 110 may include a charge storage device, such as a battery or sufficiently large capacitor, to enable the control subsystem's processor 104 to perform minor control operations, such as activating or deactivating the switching device 125, because sending the OFF signal to the switching device 125 will prohibit power from passing to both the control subsystem 110 and the computing subsystem 120 until the time period for the computing subsystem 120 to reset has expired and the control subsystem's processor 104 has sent the ON signal to the switching device 125. The control subsystem's processor performs control operations, such as entire device and computing subsystem resets, software updates, and so forth, responsive to control signals received from the remote control system 130, as well as performs various other control operations according to its stored operating instructions (e.g., software or firmware).

The architecture of the electronic device 500 illustrated in FIG. 5 may be scaled to accommodate multiple computing subsystems 120a-120n in a manner similar to the scaled architecture illustrated in FIG. 2. To perform a hard reset on one computing subsystem (e.g., computing subsystem 120a) in the scaled architecture after a reset signal identifying the affected computing subsystem is received by the control subsystem 210 from the remote control system 130, the control subsystem processor 104 may use a communication bus 209 or other signal path to provide the OFF signal to the switching device 125a for the affected computing subsystem 120a to be reset (power cycled). This same scheme can be followed to hard reset some or all the computing subsystems 120a-120n at the same time, on a one-off basis, or according to a pre-programmed sequence based on the content of the reset signal received from the remote control system 130.

In such a scaled, multiple computing subsystem embodiment, multiple switching devices 125a-125n may be used on a one-to-one basis with a respective computing subsystem 120a-120n, with each switching device 125a-125n being positioned between an output of PSU2 128 and a DC power bus or other DC power input of its associated computing subsystem 120a-120n or computing subsystem processor(s). Additionally, each computing subsystem 120a-120n may have its own unique wireless communication interface and processing unit(s) and wireless communications may occur over separate antennas 129a-129n.

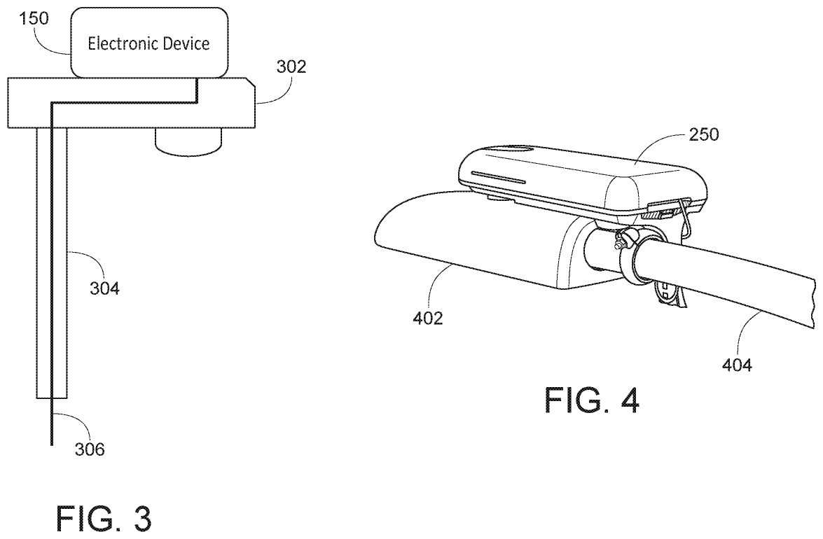

In some embodiments, the electronic device 150 includes a communication module and a lighting controller coupled to circuitry on a printed circuit board or other electronic module. In other embodiments, the electronic device 150 can be any electronic product using a multi-contact connector or a NEMA connector. In the example shown in FIG. 3, the electronic device 150 is in the form of a smart streetlight computing platform coupled to a streetlight fixture 302 and powered through a powerline interface supplying AC power from the streetlight fixture 302 to the electronic device 150. In the example shown in FIG. 4, the electronic device 250 is in the form of a smart streetlight computing platform coupled to a streetlight fixture 402 on a streetlight pole or pole arm 404.

As a smart streetlight platform, the electronic device 150, 250 can include any number of components and sensors, such as a light sensor, communication module, camera, motion sensor, microphones, and the like that can be coupled to the processors and further mounted to a housing of the electronic device. In some embodiments, the smart streetlight platform further includes power metering. In some embodiments, the smart streetlight platform is configured to mount to a pole and further includes one or more sensors for detecting an impact or a tilt orientation of the pole.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent. For example, a streetlight platform device may be described as being mounted “substantially” vertical or horizontal. In such cases, a device that is mounted exactly vertical is mounted along a “Y” axis and an “X” axis that is normal (i.e., 90 degrees or at right angle) to a plane or line formed by a “Z” axis. Different from the exact precision of a characteristic term, such as “vertical” or “horizontal,” the use of “substantially” or “about” to modify the characteristic term permits a variance of the particular characteristic by up to 30 percent.

The terms “include” and “comprise” as well as derivatives thereof, in all of their syntactic contexts, are to be construed without limitation in an open, inclusive sense, (e.g., “including, but not limited to”). The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Reference throughout this specification to “one embodiment” or “an embodiment” or “some embodiments” and variations thereof mean that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items and one or more other alternative embodiments that include fewer than all of the associated items.

As the context may require in this disclosure, except as the context may dictate otherwise, the singular shall mean the plural and vice versa.

The various embodiments described above can be combined to provide further embodiments.

What is claimed is:

1. An electronic device comprising:
an electrical power interface configured to receive alternating current (AC) power from an external power source;
a control subsystem including:
a wireless communication interface operable to receive control signals from a remote control system over a wireless network;
a processor that performs control operations according to first stored operating instructions and is responsive to the control signals received from the remote control system; and
a first power supply configured to convert the AC power received from the electrical power interface into direct current (DC) power for use by at least the processor and the wireless communication interface;
a computing subsystem operable, when powered on, to perform computing operations according to second stored operating instructions, the computing operations being independent of the control operations performed by the control subsystem;
a second power supply configured to convert the AC power received from the electrical power interface into DC power for use by at least the computing subsystem; and
a controllable switching device coupled to the second power supply and configured to: (a) enter a first state, responsive to receipt of a first control signal from the processor of the control subsystem, permitting DC power from the second power supply to pass to the computing subsystem, and (b) enter a second state, responsive to receipt of a second control signal from the processor of the control subsystem, prohibiting DC power from passing to the computing subsystem,
wherein the processor of the control subsystem provides the second control signal to the controllable switching device responsive to receipt of a computing subsystem reset control signal from the remote control system and subsequently, after passage of a period of time, provides the first control signal to the controllable switching device.

2. The electronic device of claim 1, wherein the control subsystem includes the controllable switching device and the controllable switching device is positioned between the electrical power interface and the second power supply.

3. The electronic device of claim 2, wherein the controllable switching device is a relay.

4. The electronic device of claim 1, wherein the computing subsystem includes the controllable switching device and the controllable switching device is electrically coupled to an output of the second power supply.

5. The electronic device of claim 1, wherein the control operations performed by the control subsystem include lighting control operations.

6. The electronic device of claim 1, wherein the computing operations performed by the computing subsystem include processing data received from one or more sensors coupled to the computing subsystem.

7. The electronic device of claim 6, wherein the one or more sensors include a camera.

8. The electronic device of claim 6, further comprising:
a Power over Ethernet (PoE) port, wherein a sensor of the one or more sensors is coupled to the computing subsystem through the PoE port and wherein the PoE port delivers DC power from the second power supply to the sensor and receives data from the sensor.

9. The electronic device of claim 1, wherein the computing operations performed by the computing subsystem are unrelated to the control operations performed by the control subsystem.

10. An electronic device comprising:
an electrical power interface configured to receive alternating current (AC) power from an external power source;
a control subsystem including:
a wireless communication interface operable to receive remote control signals from a remote control system over a wireless network;
a processor that performs control operations according to first stored operating instructions and is responsive to the remote control signals received from the remote control system; and
a first power supply configured to convert the AC power received from the electrical power interface into direct current (DC) power for use by at least the processor and the wireless communication interface;
a plurality of computing subsystems, wherein each computing subsystem is operable, when powered on, to perform respective computing operations according to respective stored operating instructions, the computing operations being independent of the control operations performed by the control subsystem;
a second power supply configured to convert the AC power received from the electrical power interface into DC power for use by at least the plurality of computing subsystems; and
a plurality of controllable switching devices, wherein each controllable switching device is coupled to the second power supply and configured to: (i) enter a first state, responsive to receipt of a first control signal from the processor of the control subsystem, permitting DC power from the second power supply to pass to a respective computing system of the plurality of computing subsystems; and (ii) enter a second state, responsive to receipt of a second control signal from the processor of the control subsystem, prohibiting DC power from passing to the respective computing subsystem;
wherein the processor of the control subsystem provides the second control signal to a controllable switching device associated with a particular computing subsystem responsive to receipt of a reset control signal from the remote control system identifying the particular computing subsystem and subsequently, after passage of a period of time, provides the first control signal to the controllable switching device associated with the particular computing subsystem.

11. The electronic device of claim 10, wherein each computing subsystem of the plurality of computing subsystems includes a respective controllable switching device of the plurality of controllable switching devices, and wherein the respective controllable switching device is electrically coupled to an output of the second power supply.

12. The electronic device of claim 10, wherein the control operations performed by the control subsystem include lighting control operations.

13. The electronic device of claim 10, wherein the computing operations performed by a first computing subsystem of the plurality of computing subsystems include processing data received from one or more sensors coupled to the first computing subsystem.

14. The electronic device of claim 13, further comprising:
a Power over Ethernet (PoE) port, wherein a sensor of the one or more sensors is coupled to the first computing subsystem through the PoE port, and wherein the PoE port delivers DC power from the second power supply to the sensor and receives data from the sensor.

15. The electronic device of claim 10, wherein the computing operations performed by the plurality of computing subsystems include processing data received from a plurality of sensors, the electronic device further comprising:
a plurality of Power over Ethernet (PoE) ports, wherein each sensor of the plurality of sensors is coupled to a respective computing subsystem of the plurality of computing subsystems through a PoE port of the plurality of PoE ports, and wherein each PoE port delivers DC power from the second power supply to and receives data from the sensor to which the PoE port is coupled.

16. The electronic device of claim 10, wherein the computing operations performed by each computing subsystem are unrelated to the control operations performed by the control subsystem.

17. An electronic device comprising:
an electrical power interface configured to receive alternating current (AC) power from an external power source;
a control subsystem including:
a wireless communication interface operable to receive remote control signals from a remote control system over a wireless network; and
a processor that performs control operations according to first stored operating instructions and is responsive to the remote control signals received from the remote control system;
a computing subsystem operable, when powered on, to perform computing operations according to second stored operating instructions, the computing operations being independent of the control operations performed by the control subsystem;
a power supply configured to convert the AC power received from the electrical power interface into direct current (DC) power for use by at least the computing subsystem and the control subsystem; and
a controllable switching device coupled to the power supply and configured to: (i) enter a first state, responsive to receipt of a first control signal from the processor of the control subsystem, permitting DC power from the power supply to pass to the computing subsystem, and (ii) enter a second state, responsive to receipt of a second control signal from the processor of the control subsystem, prohibiting DC power from passing to the computing subsystem,
wherein the processor of the control subsystem provides the second control signal to the controllable switching device responsive to receipt of a computing subsystem reset control signal from the remote control system and subsequently, after passage of a period of time, provides the first control signal to the controllable switching device.

18. The electronic device of claim 17, wherein the control subsystem includes the controllable switching device and the controllable switching device is positioned between the electrical power interface and the power supply.

19. The electronic device of claim 17, wherein the computing subsystem includes the controllable switching device and the controllable switching device is electrically coupled to an output of the power supply.

20. The electronic device of claim 17, wherein the computing operations performed by the computing subsystem include processing data received from one or more sensors coupled to the computing subsystem.
